(19) United States
(12) Patent Application Publication
(10) Pub. No.: US 2022/0406220 A1
(43) Pub. Date: Dec. 22, 2022

(54) NAVIGATION SYSTEM FOR THE VISUALLY IMPAIRED

(71) Applicant: Hearsee, St. George, UT (US)

(72) Inventors: James Bloomfield, Bloomington, UT (US); Timothy Relihan, Lake Worth, FL (US); Silpa Kona, Holbrook, NY (US); John Leavitt, Rockville Centre, NY (US); Christopher Stevens, Centereach, NY (US); James Wightman, Saint James, NY (US)

(21) Appl. No.: 17/843,841

(22) Filed: Jun. 17, 2022

Related U.S. Application Data
(60) Provisional application No. 63/212,009, filed on Jun. 17, 2021.

(51) Int. Cl. G09B 21/00; G08B 3/10; G06K 7/10; A61H 3/06

(52) U.S. Cl. CPC G09B 21/006; G08B 3/10; G06K 7/10366; A61H 3/061; A61H 3/068; A61H 2201/5097

(57) ABSTRACT

A method is disclosed as including sending, to a remote server, information identifying a first location within a building. In response to such sending, data may be received from the remote server. The data may comprise a plurality of unique identifiers, each unique identifier thereof corresponding to a unique radio tag located in a unique location within the building. The data may be used to deliver to a user a first series of audible commands guiding the user within the building toward the first location. For example, a first radio transmission may be received from a first radio tag located within the building. The first radio transmission may communicate a first identifier that is associated within the data to first navigation information. Thus, the first navigation information may be used to guide the user within the building toward the first location.

### RELATED APPLICATIONS

This application claims the benefit of U.S. Provisional Patent Application Ser. No. 63/212,009 filed Jun. 17, 2021, which is hereby incorporated by reference.

### BACKGROUND

### Field of the Invention

This invention relates to navigation and, more particularly, to novel systems and methods for delivering information to and facilitating indoor and/or outdoor navigation for the visually impaired.

### Background Art

Individuals who are visually impaired, and many others, have difficulty navigating in unknown or complex environments. Commonly, they must rely on traditional brail signs, marks in the walk ways, and other mechanisms to navigate in a world designed for the sighted. These static mechanisms can make navigation in known or unknown environments difficult as they cannot provide constant and real-time information to act upon. Additionally, the user must find these mechanisms, which can pose a further hurdle for the visually impaired.

### BRIEF SUMMARY OF THE INVENTION

In view of the foregoing, in accordance with the invention as embodied and broadly described herein, a method is disclosed in one embodiment as including sending, to a server (e.g., a remote server), information identifying a first location within a building. In response to such sending, data comprising a plurality of unique identifiers may be received from the server. Each unique identifier of the plurality of unique identifiers may correspond to a unique radio tag located in a unique location within the building. Accordingly, the data may be used to deliver to a user a first series of audible commands guiding the user within the building toward the first location.

For example, as a user approaches or enters the building, a first radio transmission may be received from a first radio tag located within or proximate a building (e.g., proximate an entrance to a building). The first radio tag may be a passive RFID tag, an active RFID tag, a radio beacon, or the like. The first radio transmission may communicate or encode a first identifier (e.g., a first serial number, first latitude and longitude information identifying a location of the first radio tag, or the like) that uniquely corresponds to or identifies the first radio tag. The first identifier may be associated within the data to first navigation information. Accordingly, the first navigation information may be used to guide the user within the building toward the first location.

In selected embodiments, the method may further include receiving a second radio transmission from a second radio tag located within the building. The second radio transmission may communicate or encode a second identifier (e.g., a second serial number, second latitude and longitude information identifying a location of the second radio tag, or the like) that uniquely corresponds to or identifies the second radio tag. The second identifier may be associated within the data to second navigation information. Accordingly, the second navigation information may be used to guide the user within the building toward the first location.

For example, the data may indicate that a location of the second radio tag is adjacent in a first direction to a location of the first radio tag. Accordingly, if the second radio transmission is received soon (e.g., immediately) after the first radio transmission, it may be indicative of the direction being traveled by the user, which may be factored in when guiding the user within the building to the first location.

At some point, a third radio transmission may be received from a third radio tag located within the building. The third radio transmission may communicate or encode a third identifier (e.g., a third serial number, third latitude and longitude information identifying a location of the third radio tag, or the like) that uniquely corresponds to or identifies the third radio tag. The third identifier may be associated within the data to third navigation information. Accordingly, the third navigation information may be used to guide the user within the building toward the first location. Thus, as a user progresses on a path through the building, one or more devices carried thereby may encounter various radio tags and use the information derived therefrom to assist in guiding the user within the building to the first location.

In selected embodiments, as some point in time, information identifying a second location within the building may be received from the user. Accordingly, the data may be used to issue a second series of audible commands that guide the user toward the second location. For example, the user may change his or her mind as to where he or she would like to go within the building and change an intended or desired destination from the first location to the second location. Alternatively, once the user has arrived at the first location and completed whatever tasks may be associated with that location, he or she may desire to move on to a second location (e.g., be guided to an exit door of the building).

In selected embodiments, a system in accordance with the present invention may be or comprise a server supporting navigation of one or more users through one or more buildings. Such a system may comprise at least one processor and memory operably connected to the at least one processor. The memory may store data. The data may comprise a plurality of unique identifiers. Each unique identifier may correspond to a unique radio tag located in a unique location within a building. The data may further comprise one or more attributes for each unique identifier. The one or more attributes may characterize the unique location within the building at which the unique radio tag corresponding to each unique identifier is located.

For example, the plurality of unique identifiers may comprise a first unique identifier, a second unique identifier, and a third unique identifier. The first unique identifier may correspond to a first unique radio tag located in a first unique location within the building. The second unique identifier may correspond to a second unique radio tag located in a second unique location within the building. The third unique identifier may correspond to a third unique radio tag located in a third unique location within the building. Accordingly, the one or more attributes for the first unique identifier may characterize the first unique location, the one or more attributes for the second unique identifier may characterize the second unique location, and the one or more attributes for the third unique identifier may characterize the third unique location.

In certain embodiments, the one or more attributes for the first unique identifier may characterize the first unique location as being adjacent an entrance to a restroom contained within the building, an entrance to an elevator contained within the building, or an entrance to an office contained within the building. Other suitable attributes may include information identifying which other unique locations are adjacent and in which directions, other adjacent locations that may serve as desired destinations for certain users, or the like. Thus, the collection of attributes stored within the data may support navigation along various paths to various destinations within the building.

In selected embodiments, the memory may further store instructions that cause the at least one processor to serve the data in response to a query comprising at least one unique identifier of the plurality of unique identifiers. Thus, once a software application corresponding to a user encounters a first radio transmission corresponding to a building or a portion of a building, that software may send a unique identifier corresponding to that transmission to the system and the system may return all the data required to navigate through the building or the portion of the building.

In certain embodiments, a method may enable or equip a building to support navigation in accordance with the present invention. Such a method may comprise virtually dividing at least a portion of a floor of a building into a plurality of sections and mapping the plurality of sections to a plurality of radio tags. The mapping may assign one radio tag of the plurality of radio tags to one section of the plurality of sections. Thus, each section may have one radio tag assigned thereto and each radio tag may be assigned to one section. The plurality of radio tags may be installed within the building according to the mapping.

The method may further comprise programming the plurality of radio tags such that each radio tag thereof has a unique identifier (e.g., a unique serial number). Additionally, in certain embodiments, the method may include programming a computer system with a mapping of the unique identifier of each radio tag to one or more attributes of a section corresponding to that radio tag.

For example, the plurality of radio tags may comprise a first radio tag, a second radio tag, and a third radio tag. The first radio tag may be installed within a first section of the plurality of sections, the second radio tag may be installed within a second section of the plurality of sections, and the third radio tag may be installed within a third section of the plurality of sections. Thus, the one or more attributes corresponding to the first section may be mapped in the programming to a unique identifier of the first radio tag, the one or more attributes corresponding to the second section may be mapped in the programming to a unique identifier of the second radio tag, and the one or more attributes corresponding to the third section may be mapped in the programming to a unique identifier of the third radio tag.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a perspective view of an example of a navigation system for the visually impaired according to various embodiments described herein;

FIG. 2 illustrates an enlarged perspective view of an example of a reading device according to various embodiments described herein;

FIG. 3 shows an enlarged perspective view of another example of a reading device according to various embodiments described herein;

FIG. 4 depicts an enlarged perspective view of an example of a client device according to various embodiments described herein;

FIG. 5 illustrates a cross-sectional elevation view of an example of a radio tag coupled to an object and a surface according to various embodiments described herein;

FIG. 6 shows a block diagram of an example of a reading device according to various embodiments described herein;

FIG. 7 depicts a block diagram of an example of a client device according to various embodiments described herein;

FIG. 8 illustrates a block diagram of an example of a processing unit according to various embodiments described herein;

FIG. 9 is a side view of a reading device configured as a cane or walking stick;

FIG. 10 is a side view of one embodiment of a handle of a cane or walking stick in accordance with the present invention;

FIG. 11 is a schematic diagram of one embodiment of the electronics of a reading device in accordance with the present invention;

FIG. 12 is a schematic diagram of an alternative embodiment of a system in accordance with the present invention wherein the reading device is incorporated within a cane or walking stick, the client device is incorporated within or comprises a software application running on a smart phone or other mobile device, and the client device is in communication with a server (e.g., a remote server);

FIG. 13 is a schematic diagram of one embodiment of speech to text functionality that may be supported or provided by a client device in accordance with the present invention;

FIG. 14 is a flow chart of one embodiment of a method for building out a space with radio tags in accordance with the present invention;

FIG. 15 is a sample floor plan of an office building that may be built out with the radio tags in accordance with the present invention;

FIG. 16 is a flow chart of a method for using a system in accordance with the present invention;

FIG. 17 is a workflow diagram of RFID sensing functionality that may be supported or provided by a system in accordance with the present invention;

FIG. 18 is a screen shot of a home screen of one embodiment of a software application forming a client device or providing certain functionality of a client device in accordance with the present invention;

FIG. 19 is a screen shot of a home screen of the software application of FIG. 18 as a voice command is being received by the software application;

FIG. 20 is a screen shot of the software application of FIG. 18 as the software application searches for information or data that may be responsive or relevant to a voice command received by the software application;

FIG. 21 is a screen shot of the software application of FIG. 18 as the software application presents a listing of results (e.g., potential destinations) that may be responsive or relevant to a voice command received by the software application;

FIG. 22 is a screen shot of the software application of FIG. 18 as the software application presents a navigation instruction set that will direct a user to a particular destination; and

FIG. 23 is a workflow diagram of cane-finding functionality that may be supported or provided by a system in accordance with the present invention.

### DETAILED DESCRIPTION OF SELECTED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

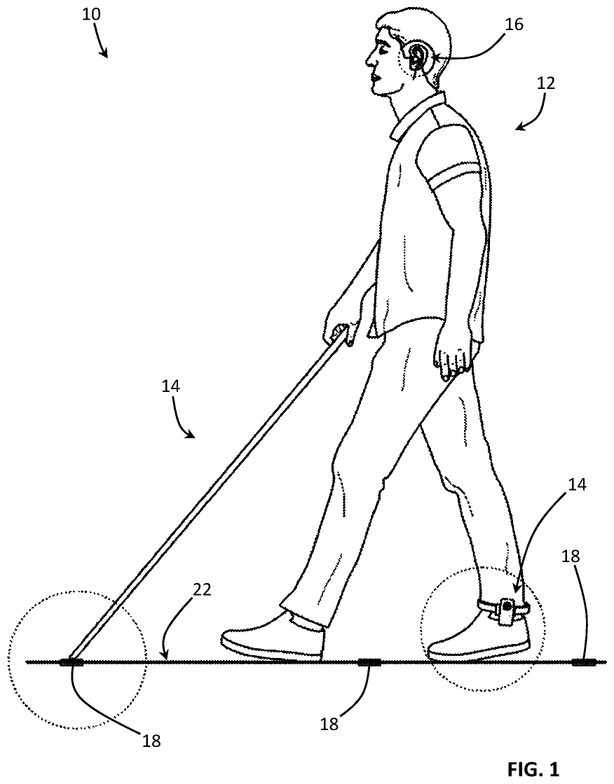

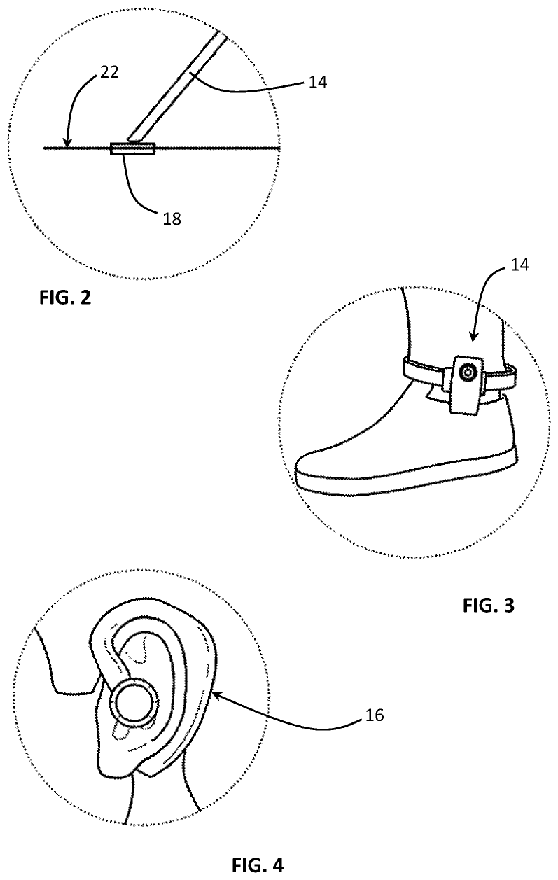

Referring to FIGS. 1-5, a navigation system 10 for the visually impaired 12 and/or other individuals 12 may comprise one or more reading devices 14, client devices 16, and radio tags 18. A reading device 14 may be an assistive device, wearable, or the like that is carried, manipulated, and/or worn by a user 12. A client device 16 may be, comprise, or form part of a smart phone, an earpiece, a smart phone and earpiece or headphone combination, a wrist device, or the like.

In selected embodiments, an earpiece, headphone, or the like forming or associated with a client device 16 may include a pass-through feature or ambient-sound mode that helps a user to hear what is known as “ambient noise,” even while wearing the earpiece, headphone, or the like. In an ambient sound mode, an earpiece, headphone, or the like may enable a user to control a volume of ambient sound independent of other sounds played by the earpiece, headphone, or the like (e.g., independent of tones, voice-based instructions or information, or the like passed from a client device 16 to an earpiece, headphone, or the like). In certain embodiments, an earpiece, headphone, or the like may include a pressure relief valve (e.g., a one-way or two-way pressure relief valve) that may release or resolve any pressure differential that may exist between an inner space (i.e., a space between an output of an earpiece or the like and an ear drum of a user) and an outer or ambient space.

In certain embodiments, each reading device 14 may be in communication with a respective client device 16. One or more radio tags 18 may be disposed in an environment by being connected to a plurality of objects 20 and/or surfaces 22. A reading device 14 may be manipulated by a user 12 so that the reading device 14 may be placed in proximity to a radio tag 18. Accordingly, a radio tag 18 may wirelessly pass data to a reading device 14 and a reading device 14 may wirelessly pass data to a client device 16.

The data passed from a radio tag 18 to a reading device 14 may include information describing the environment proximate to the radio tag 18, such as location data, addresses, building names, navigation way-points inside buildings, etc. The client device 16 may output the data to the user 12 in audible, visual, and/or tactile format. Alternatively, the data may simply comprise a serial number or the like. Accordingly, after a reading device 14 passes the serial number to a client device 16, the client device 16 may use the serial number to download, look up, or otherwise obtain information that has been linked to that serial number. This information or some portion or derivative thereof may be output to the user 12 in audible, visual, and/or tactile format or may be used by the client device 16 to provide some other benefit to the user 12 (e.g., support computerized navigation of the user 12 to a particular destination, provide contextual information to the user 12 such as location data, addresses, direction of travel, building names, points of interest and cultural significance, or any other information that may be useful for keeping the user 12 constantly or regularly appraised of his or her exact location, direction of travel, surroundings, etc.).

In selected embodiments, a system 10 may comprise a plurality of radio tags 18 coupled or secured to objects and/or surfaces such as buildings, fences, sign posts, light posts, traffic signals, roads and their surfaces, sidewalks, and the like. Alternatively, or in addition thereto, one or more radio tags 18 may be disposed on, along, and/or proximate certain walkways (e.g., areas that a user 12 may walk along or through to get to a destination) so that the information they contain may be read by a reading device 14 and benefit a user 12 moving or navigating along those walkways. In certain embodiments, the radio tags 18 may be disposed on or coupled to steps, hallways, staircases, doors, barriers, walls, ceilings, base boards, flooring, or any other object associated with walkways.

In certain embodiments, radio tags 18 may comprise radio-frequency identification (RFID) tags that contain electronically stored information. Encoded electromagnetic transmissions may be used to pass data from one or more radio tags 18 to one or more reading devices 14. In selected embodiments or locations, one or more radio tags 18 may be or comprise passive RFID tags that collect and use energy from a nearby RFID reader's interrogating radio waves to produce a reply (e.g., a response comprising an electromagnetic transmission). In other embodiments or locations, one or more radio tags 18 may be or comprise active RFID tags that have a power source (e.g., a battery and/or wired power connection) and may communicate with (e.g., pass information to) an RFID reader located farther away therefrom. In still other embodiments or locations, one or more radio tags 18 may comprise Bluetooth Low Energy (BLE) beacons.

In certain embodiments, a system 10 may comprise one or more radio tags 18 that may be in wired communication, such as via wires, leads, conductive strips, low voltage wire, or other wired connection, with one or more power sources. The one or more power sources may provide power to the radio tags 18. Alternatively, or in addition thereto, wires or the like may enable one or more radio tags 18 to communicate with one or more computing devices (e.g., an RFID programming unit) that may be used to modify the data that the radio tags 18 emit in response to a reading device 14. In selected embodiments, radio tags 18 may comprise any type of device that may wirelessly communicate information to a reading device 14 of a user 12 as the user 12 moves or navigates through an environment.

A reading device 14 may be or be located within a cane, walking stick, walker, some other assistive device, bracelet, shoe, ankle bracelet, some other wearable device, or the like. Accordingly, as a user 12 navigates or moves through an environment, a reading device 14 carried by the user 12, carried by a guide animal corresponding to the user 12 (e.g., included within a collar, leash, or harness of a guide animal), or the like may pass within range of one or more radio tags 18 (e.g., one or more RFID tags, RFID beacons, BLE beacons, or the like or combinations or sub-combinations thereof) positioned within that environment. For example, a reading device 14 located (or having an antenna located) proximate a tip of a cane or walking stick, in an ankle bracelet, or in some other appropriate location on or within an assistive device or wearable may pass in close proximity to one or more radio tags 18 secured to a floor, base board, or lower wall surface. This may facilitate reliable communication between the radio tags 18 and the reading device 14, particularly when the radio tags 18 are configured as passive RFID tags.

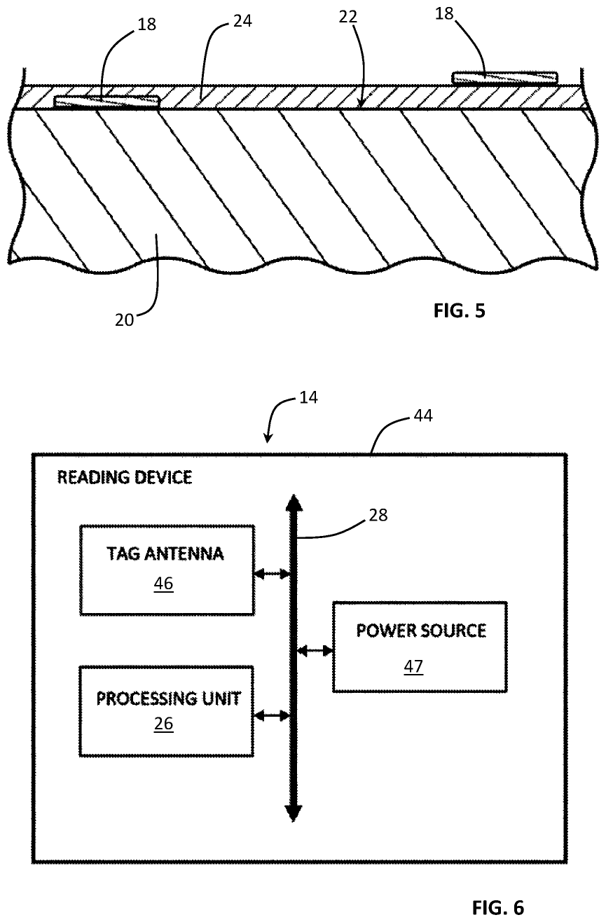

Referring to FIG. 5, one or more radio tags 18 may be affixed, embedded, or otherwise coupled to various objects 20 and surfaces 22. In certain embodiments, a radio tag 18 may be coupled to an object 20 or surface 22 via a fixative 24. A fixative 24 may comprise an adhesive, glue, heat bonding element, fastener (e.g., a nail, screw, bolt, rivet, staple, etc.), or the like. Alternatively, one or more radio tags 18 may be imbedded in various objects 20 or surfaces 22 during construction and/or be painted on to objects 20 and surfaces 22 (e.g., installed and then painted over) during or after construction. Accordingly, radio tags 18 may be incorporated within an environment (e.g., a building) as part of an original construction effort or in a retrofit or upgrading process.

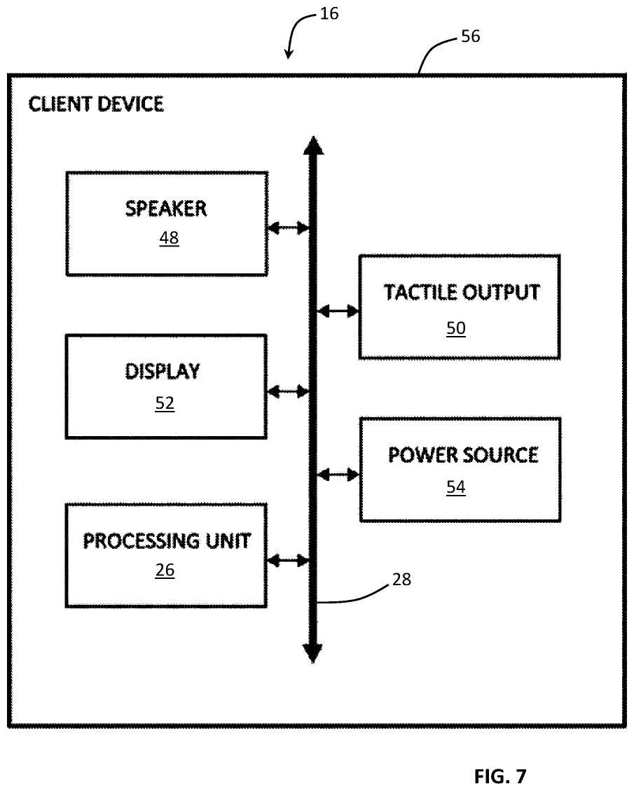

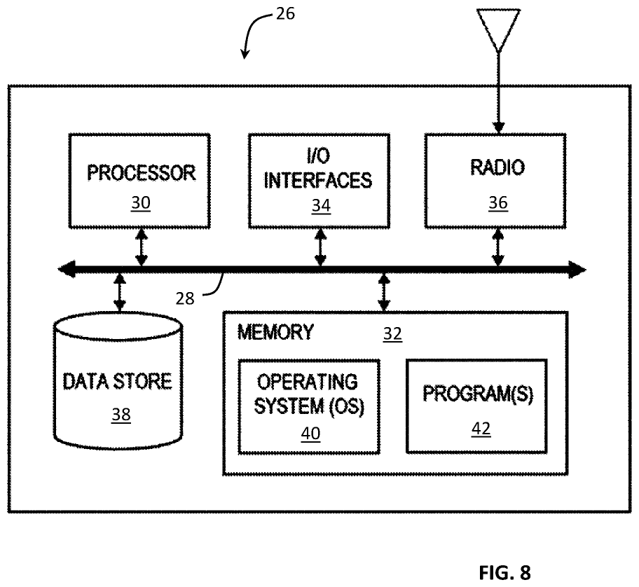

Referring to FIGS. 6-8, in certain embodiments, reading devices 14 and/or client devices 16 of a system 10 in accordance with the present invention may comprise or be configured as digital devices comprising one or more processing units 26. FIG. 8 depicts an example of a relatively simple processing unit 26. In other embodiments, a processing unit 26 may include additional components or elements.

The components of a reading device 14 and a client device 16 may be communicatively coupled via a local interface 28, The local interface 28 can be, for example but not limited to, one or more buses or other wired or wireless connections, integrated circuits, etc. The local interface 28 may have additional elements such as controllers, buffers (caches), drivers, repeaters, receivers, or the like or a combination or sub-combination thereof to support a desired functionality. Further, a local interface 28 may include addressing, control, and/or data connections to enable appropriate communications among various components connected thereto.

A processor 30 may be a hardware device for executing software instructions. Accordingly, when a processing unit 26 is in operation, a processor 30 may execute software stored within memory 32, communicate data to and from memory 32, and/or otherwise control operations of a corresponding device 14, 16 pursuant to the software instructions. In an exemplary embodiment, the processor 30 may be or comprise a mobile optimized processor that is optimized for lower power consumption requirements or goals typically associated with mobile applications.

In selected embodiments, one or more I/O interfaces 34 may be used to input and/or output information and/or power. In some embodiments, I/O interfaces 34 may include one or more turnable control knobs, depressible button-type switches, key pads, slide-type switches, dip switches, rocker-type switches, rotary dial switches, numeric input switches, or any other suitable input through which a user 12 may interact with a processing unit 26 or device 14, 16. In certain embodiments, one or more I/O interfaces 34 may include one or more light emitting elements or other display devices (e.g., one or more light emitting diodes), one or more speakers, and/or any other suitable device for outputting or displaying information. One or more I/O interfaces 34 may also include a serial port, a parallel port, a small Computer System interface (SCSI), an infrared (IR) interface, a radio frequency (RF) interface, a universal serial bus (USB) interface, and/or the like.

A radio 36 may enable wireless communication to an external access device or network. In selected embodiments, a radio 36 may operate via Bluetooth and/or WiFi communication standards. Alternatively, or in addition thereto, a radio 36 may operate on a cellular band and may communicate with or receive a Subscriber Identity Module (SIM) card or other wireless network identifier. Any number of suitable wireless data communication protocols, techniques, or methodologies may be supported by a radio 36, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Near-Field Communication (NFC); Frequency Hopping Spread Spectrum; Long Term Evolution (LTE); cellular/wireless/cordless telecommunication protocols (e.g., 3G, 4G, 5G, or the like); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and/or any other protocols for wireless communication.

A data store 38 may be used to store data. A data store 38 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, a data store 38 may incorporate electronic, magnetic, optical, and/or other types of storage media.

Memory 32 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, memory 32 may incorporate electronic, magnetic, optical, and/or other types of storage media. Memory 32 may have a distributed architecture, wherein various components are situated remotely from one another, but can be accessed by the processor 30. Software stored in memory 32 may include one or more software programs, each of which may include an ordered listing of executable instructions for implementing logical functions.

In certain embodiments, software stored in memory 32 may include an operating system (OS) 40 and one or more programs 42 or applications 42. An operating system 40 may be LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (available from Research in Motion), Raspbian (available from the Raspberry Pi Foundation), or the like. One or more programs 42 may include various applications, add-ons, or the like that are configured to provide certain functionality for the device 14, 16. For example, one or more programs 42 may include, but are not limited to, environmental variable analytics and modulation of input/output interface 34 functions. In certain embodiments, an end user 12 may use one or more programs 42 to control one or more functions of a device 14, 16.

In selected embodiments, a reading device 14 may be a digital device that, in terms of hardware architecture, may optionally comprise one or more processing units 26, a tag antenna 46, and a power source 47. In other embodiments, a reading device 14 may include additional components or elements and suitably configured processing logic to support desired functionality.

One or more components of a reading device 14 may be contained in or coupled together via a reading device housing 44. A reading device housing 44 may be configured in any size and shape. In certain embodiments, a reading device housing 44 may be configured as a white cane such as may be used by those who are blind or visually impaired. In other embodiments, a reading device housing 44 may be configured as any other type of assistive device such as a walking stick, walking cane, hiking stick, walker, or the like or a wearable that may be used by a user 12 when moving through an environment. In selected embodiments, a reading device housing 44 may be configured as an ankle bracelet that may be worn around an ankle of a user 12. In other embodiments, a reading device housing 44 may be configured as an article of footwear, such as a shoe that may be worn on a foot of the user 12. In still other embodiments, a housing 44 may be coupled to or removably coupled to objects such as white canes so that the objects may be retrofit to become reading devices 14 within a system 10 in accordance with the present invention. In certain embodiments, a reading device housing 44 may be collapsible or foldable to facilitate storage of the reading device 14.

A tag antenna 46 may be configured to read the data of a radio tag 18 located proximate thereto. In selected embodiments, a tag antenna 46 may be configured as part of a Passive Reader Active Tag (PRAT) system that receives radio signals from active radio tags 18. In other embodiments, a tag antenna 46 may be configured as part of an Active Reader Passive Tag (ARPT) system that transmits interrogator signals and receives authentication replies from passive radio tags 18. In still other embodiments, a tag antenna 46 may be configured as part of an Active Reader Active Tag (ARAT) system wherein active radio tags 18 are awoken with an interrogator signal from an active reader. In still other embodiments, a tag antenna 46 may be configured to work with radio tags 18 that are Battery-Assisted Passive (BAP) tags that act like passive tags, but have small batteries to power a return reporting signal output by the tag to increase the range of that signal. Accordingly, a tag antenna 46 may comprise any device or system that facilitates or enables wirelessly receiving data from a radio tag 18.

A reading device 14 may comprise a power source 47 that may provide electrical power to any component thereof that requires electrical power. A power source 47 may comprise a battery, a fuel cell, a capacitor, a super capacitor, or any other type of energy storing and/or electricity releasing device. In certain embodiments, a power source 47 may comprise a power cord, kinetic or piezoelectric battery charging device, a solar cell or photovoltaic cell, and/or inductive charging or wireless power receiver. In other embodiments, a power source 47 may include a power charging and distribution module that may be configured to control a charging, recharging, and/or discharging process and/or the distribution of power to one or more components of a reading device 14.

A client device 16 may be a digital device that, in terms of hardware architecture, may optionally comprise one or more processing units 26, a speaker 48, a tactile output 50, a display 52, a power source 54, or the like or a combination or sub-combination thereof. In other embodiments, a client device 16 may include one or more additional components or elements to support desired functionality.

One or more components of a client device 16 may be contained in or coupled together via a client device housing 56. A client device housing 56 may be configured in any size and shape. In preferred embodiments, a client device 16 and its housing 56 may be configured as a smart phone, tablet computer, or other handheld computing device. In certain embodiments, a client device 16 and its housing 56 may be configured as an ear piece or headset which may be worn by a user 12 when moving through an environment. In still other embodiments, a client device 16 and its housing 56 may be configured to be worn on other parts of the body of a user 12, such as on the ankle, waist, wrist, shoulder, and/or any other body location that may allow the client device 16 to be worn by a user 12 when moving through an environment.

A client device 16 may comprise or be connected to a speaker 48 (e.g., wired or wireless headphones) configured to output audible information to a user 12. In selected embodiments, a speaker 48 may be configured to produce sounds (e.g., one or more voices, tones, or the like) that may be used to audibly communicate selected information to a user 12.

In selected embodiments, a client device 16 may comprise a tactile output 50, audible output (e.g., a piezoelectric buzzer), or the like or a combination thereof that may be configured to output tactile and/or audible information to a user 12. Preferably, a tactile output 50 may be configured to produce vibrations and/or pulses that may be used to communicate selected information to a user 12. A tactile output 50 may comprise a long life brushless (BLDC) vibration motor, a coin or pancake vibration motor, an encapsulated vibration motor, an enclosed vibration motor, a pager motor, an eccentric rotating mass (ERM) motor, a linear resonant actuator (LRA), a printed circuit board (PCB) mounted vibration motor, or any other electrical device capable of producing a series of rapid and/or repeated movements. In selected embodiments, a tactile output 50, audible output (e.g., a piezoelectric buzzer), and/or the like may be included as part of a reading device 14 (e.g., a reading device 14 configured as a cane or walking stick). Accordingly, a reading device 14 may produce vibrations, pulses, sounds, or the like or a combination thereof that may be used to communicate selected information to a user 12.

A client device 16 may comprise a display 52 which may be configured to output visual information to a user 12. In selected embodiments, a display 52 may be configured to provide visual information to a user 12 and, optionally, to receive input from a user 12 (e.g., a display 52 may comprise or be a touch screen display).

A client device 16 may comprise a power source 54 that may provide electrical power to one or more components of the client device 16. A power source 54 may comprise a battery, a fuel cell, a capacitor, a super capacitor, or any other type of energy storing and/or electricity releasing device. In other embodiments, a power source 54 may comprise a power cord, kinetic or piezoelectric battery charging device, a solar cell or photovoltaic cell, and/or inductive charging or wireless power receiver. In certain embodiments, a power source 54 may include a power charging and distribution module that may be configured to control a charging, recharging, and/or discharging process and/or the distribution of power to one or more components of a client device 16.

In selected embodiments, a reading device 14 and a client device 16 may be integrally formed or otherwise coupled together so that the reading device 14 and client device 16 may be in communication via a wired local interface 28. In other embodiments, a reading device 14 and a client device 16 may be separate from each other and may communicate wirelessly via their respective radios 36.

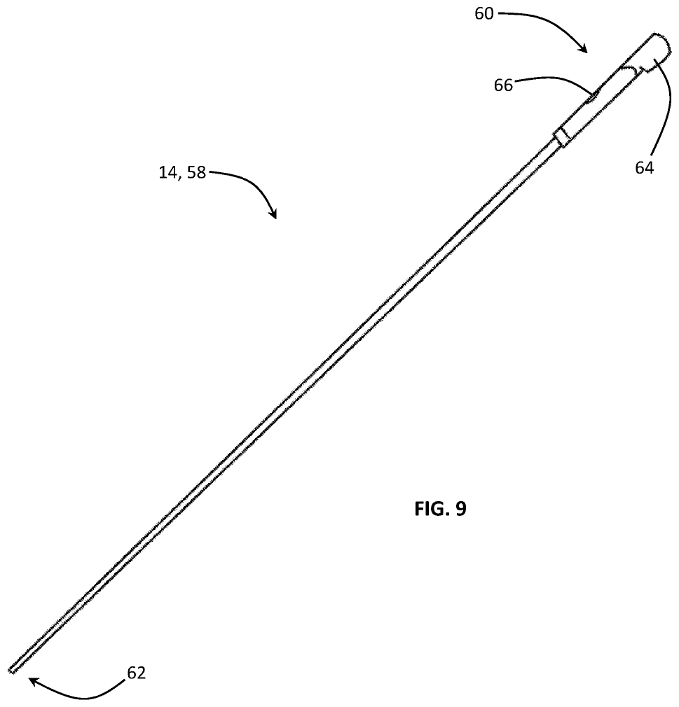

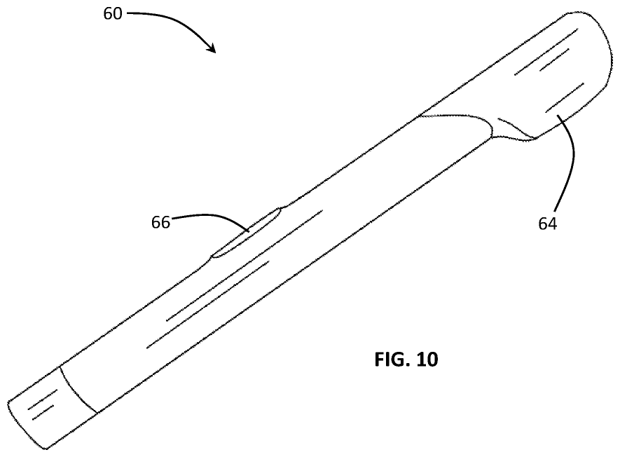

Referring to FIGS. 9 and 10, a reading device 14 may be configured as or form part of a cane 58 or walking stick 58. For example, a printed circuit board (and the various components thereof or associated therewith) may be position within a handle 60 of a cane 58. One or more batteries 47, a tactile output 50, and the like may also be contained within the handle 60. One or more antennas 46 (e.g., an RFID reader antenna) may be configured within a tip 62 of a cane 58. Accordingly, wiring (e.g., coaxial cable) may extend from an antenna 46 in a tip 62 of the cane 58 to a printed circuit board in the handle 60 of the cane 58 (e.g., to a printed circuit board in a bulge or protrusion 64 formed in the handle 60 of the cane 58).

In selected embodiments, a cane 58 may include a button 66 or switch 66 that may be used to turn a reading device 14 “ON” and “OFF.” Such a button 66 or switch 66 may be raised or otherwise shaped so as to be easily felt and identified by a user 12. A tactile output 50 and/or buzzer may be used to provide non-visual feedback that a reading device 14 has been properly turned ON or OFF. Various lights (e.g., red, green, and/or yellow LEDs) may also provide feedback as to a current state or condition of a reading device 14. In certain embodiments, a reading device 14 may include a port (e.g., a USB-C port) that may enable charging of one or more batteries 47.

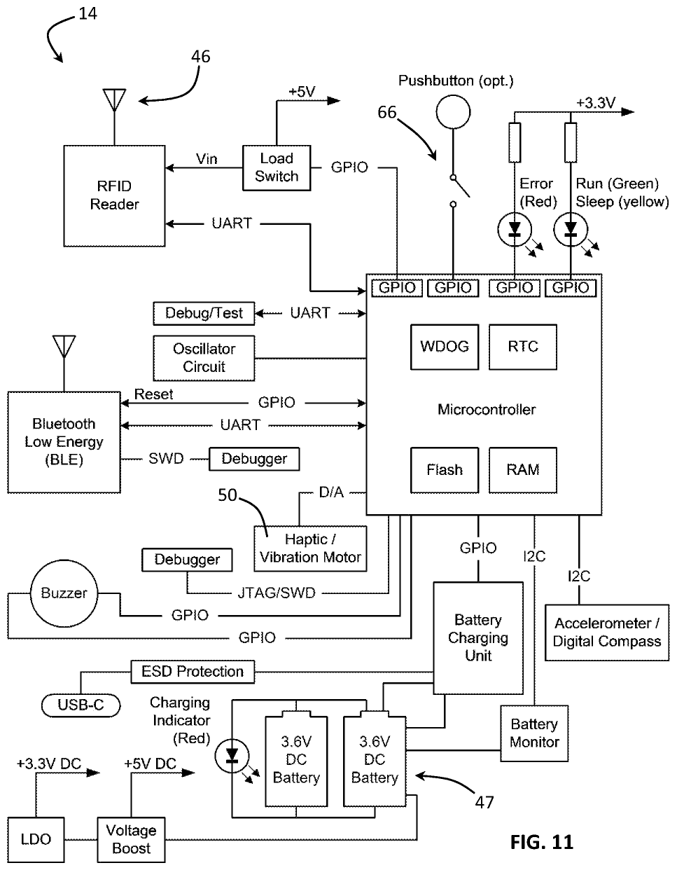

Referring to FIG. 11, in selected embodiments, the electronics of a cane 58 or other reading device 14 (e.g., other reading device 14 configured as an assistive device or a wearable) may include a microprocessor. The microprocessor may be connected to various LED lights, a switch 66, an RFID reader with a corresponding tag antenna 46, an oscillator circuit, a BLE module with corresponding antenna, a haptic or vibration motor (i.e., a tactile output 50), a buzzer, a battery charging unit, a battery monitor, an accelerometer or digital compass, or the like or a combination or sub-combination thereof. The connections between the microprocessor and such components may have the format or be of the type as labeled. In certain embodiments, the battery charging unit may be connected to one or more batteries 47, a USB-C port, or the like or a combination thereof.

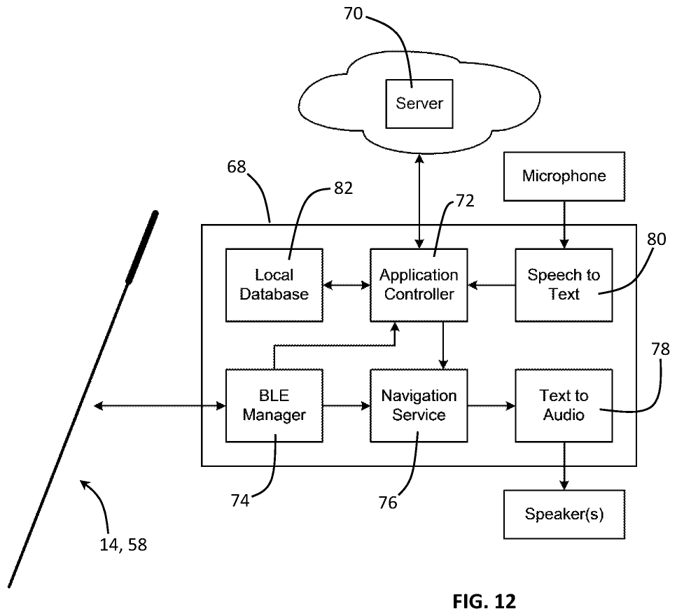

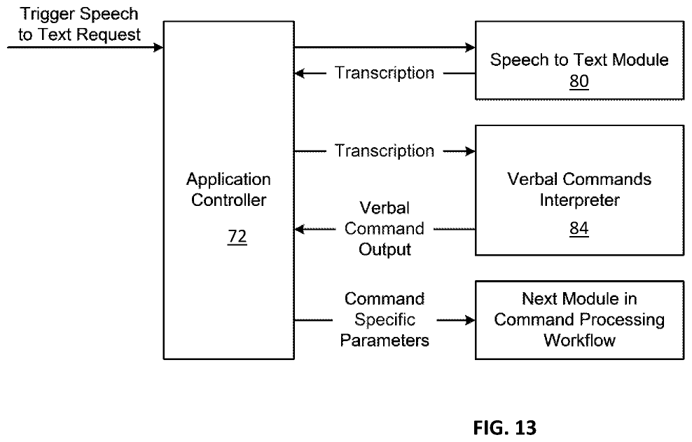

Referring to FIGS. 12 and 13, in selected embodiments, a system 10 may comprise a reading device 14 configured as a cane 58 or walking stick 58, a client device 16 comprising or configured as an application 68 running on a mobile device (e.g., on a smart phone) carried by a user 12, and a remote server 70. The application 68 may include an application controller 72, BLE manager 74, navigation service module 76, text-to-audio module 78, speech-to-text module 80, local database 82, and the like or a combination or sub-combination thereof.

During operation, a reading device 14 may wirelessly pass (e.g., via BLE) certain data (e.g., one or more serial numbers of one or more radio tags 18) to an application 68 (e.g., to a BLE manager 74 of an application 68). The application 68 (e.g., an application controller 72 of the application 68) may pass the one or more serial numbers to a server 70 and/or use the serial numbers as part of a request for data (e.g., a request for a database or one or more tables) from the server 70. In response, a server 70 may serve to the application 68 certain data corresponding to the serial numbers. That data may thereafter be stored within a local data store or database 82 (e.g., a database stored within memory of a smart phone or other mobile device). Accordingly, the client device 14 may use that locally stored data to provide benefit to a user 12.

For example, as a user 12 enters a building or other space, a reading device 14 may substantially immediately collect a serial number from a radio tag 18 located proximate an entrance to the building or space. This serial number may be passed from the reading device 14 to a client device 16 (e.g., an application 68 running on a smart phone or other mobile device) and from the client device 16 to a remote server 70 (e.g., a service connected to the Internet and accessed via a data connection of the smart phone or other mobile device). The server 70 may recognize the serial number as pertaining to a particular space and serve to the client device 16 a database or one or more tables corresponding to that space. Such a database or collection of tables may identify the various serial numbers of the various radio tags 18 located in the space and identify what attributes are linked to each of those serial numbers. Accordingly, upon entering the building or space, a client device 16 may be ready to assist the user 12 in navigating to any desired destination within that space.

In selected embodiments, a client device 16 (e.g., a speech-to-text module 80 of an application 68) may support speech to text conversions. The client device 16 (e.g., a text-to-audio module 78 module of an application 68) may support text to speech conversions. In certain embodiments, this may be done or facilitated by leveraging certain speech to text and/or text to speech functionality built into an operating system 40 of a smart phone or other mobile device that forms the hardware portion of (or enables the operation of) the client device 16.

In operation, a user may trigger a speech to text request. An application controller 72 may receive this request and pass the corresponding audio to the speech-to-text module 80. The speech-to-text module 80 may return a transcription of the audio to the application controller 72. The application controller 72 may send the transcription to a verbal commands interpreter 84, which may return to the application controller 72 verbal commands corresponding to the transcription. The application controller 72 may then command specific parameters and the next module in the command processing workflow may continue the process or work to implement or act on the specific parameters.

Accordingly, a user 12 may issue a command such as “navigate to men's room.” This command may be converted to text. The text may then be analyzed to determine the nature of the command. For example, by analyzing the text of the command to “navigate to men's room,” the client device 16 may determine that navigation services are desired and that the destination is a men's restroom. Accordingly, the client device 16 may identify within the data obtained from the server 70 where the nearest men's restroom is located and formulate instructions for conducting or guiding the user 12 from a current location to that men's restroom. These instructions may be converted to speech and passed to the user 12 via a speaker, headphone, or the like. Because the data for the space may be obtained from the server 70 early in the process and then stored locally, navigation of the user 12 to any of one or more destinations within the space may be provided even in situations where a data connection between a client device 16 and a server 70 is lost, weak, or otherwise problematic.

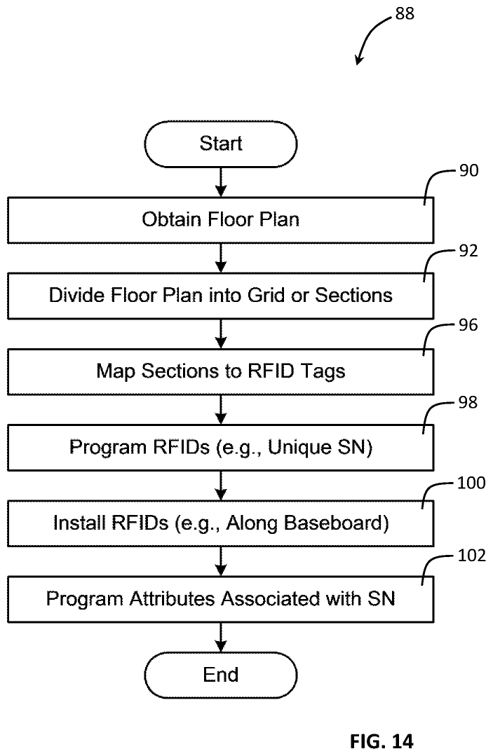

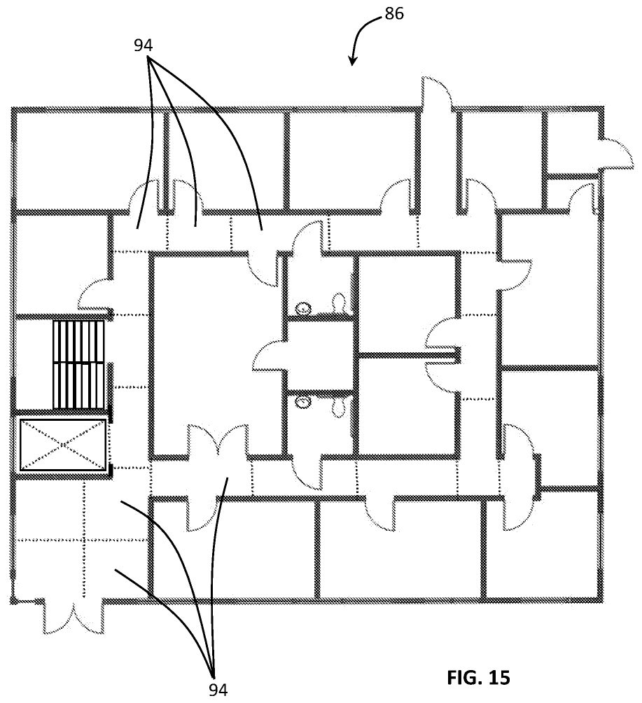

Referring to FIGS. 14 and 15 to support the operation of a system 10 in accordance with the present invention, one or more spaces 86 may be built out with a plurality of radio tags 18. A space 86 may be a location or environment where certain current forms of navigation (e.g., GPS navigation) may be compromised, unavailable, and/or insufficiently precise. For example, a space 86 may be an interior of a building such as an office building, court house, hospital, museum, conference center, hotel, airport terminal, stadium, subway station, shopping center, supermarket, parking garage, or the like. In other words, a space 86 may be a building that receives a significant number of visitors that are not completely knowledgeable regarding where everything is located within that building. Moreover, a space 86 may be a building wherein the owners and/or operators thereof may be motivated by good will, financial interest, and/or legal requirements to make the space more readily accessible to visually impaired users 12.

A method 88 of building out a space 86 may begin with obtaining 90 a floor plan of the space 86. Thereafter, the floor plan may be logically or virtually divided 92 into a grid or plurality of segments or sections 94. The granularity of a grid (e.g., the number of grid sections 94) may be selected to support a desired precision of navigation. In certain embodiments, each grid section 94 may be located and/or sized such that a relatively few steps (e.g., 3 to 5 steps) may transition a user 12 from one grid section 94 to an adjacent grid section 94. For example, from the center of one grid section 94 to the center of an adjacent grid section 94 may be about ten feet. This level of granularity may be economically feasible while still providing enough navigational touch points to avoid unnecessary or undesirable ambiguity or imprecision.

In the sample office-building floor plan shown in FIG. 15, the walking spaces that would need to be divided 92 into a grid are rather narrow. They consist of relatively narrow hallways (e.g., hallways that are about ten feet wide or less) that extend to connect elevators, stairs, restrooms, offices, etc. Accordingly, a grid for such a floor plan may be relatively simple and comprise a series of sections 94 that extend from one side of the hallway to the other and typically only boarder adjacent sections 94 on two opposite ends thereof. As appreciated a more open floor plan such as what may be found in a museum may be divided 74 into a grid where many sections 94 thereof are completely surrounded by other sections 94 of the grid.

Once a floor plan has been logically or virtually divided 92 into a grid or plurality of sections 94, each of the grid sections 94 may be mapped 96 to a unique radio tag 18 (e.g., a unique RFID tag, RFID beacon, BLE beacon, or the like). Such mapping 96 may include deciding which radio tags 18 may best fit which grid sections 94 (e.g., larger sections or segments may be better served by active RFID tags, RFID beacons, BLE beacons, or the like due to the greater distances that may be involved), deciding where within each section 94 should the radio tag 18 be placed, and/or the like. Thereafter, the radio tags 18 may be programmed 98 (e.g., programmed with a unique serial number) and installed 100 within the actual space 86.

As part of an installation process, records may be kept or created that identify which radio tags 18 (e.g., which serial numbers) correspond to which attributes of a space 86. For example, certain radio tags 18 may be waypoints and nothing more. That is, they may correspond to areas that must be walked through to get to one or more destinations, but they may not be destinations themselves. Other radio tags 18 may be waypoints and destinations. In other words, they may correspond to a portion of a hallway that must be walked through to get to one or more destinations, but they may also be a destination themselves because they are immediately outside of a particular office. Accordingly, in some computerized record (e.g., a database, one or more tables, or the like), the serial numbers of the various radio tags 18 may be associated 102 with (e.g., programmed to correspond to) the attributes of that location within the space 86. Attributes may include being (1) a starting point (e.g., an entrance to a particular building, an entrance to a particular floor, etc.), (2) an ending point (e.g., a destination within or exit for a particular building), (3) a waypoint that is adjacent one or more other waypoints in certain directions, and/or (4) adjacent on a specified side to a men's restroom, women's restroom, elevator door, stairway, stairway door, drinking fountain, vending machine, kiosk, reception desk, office door, safety hazard, or any other feature that could be important to a user 12 moving within or navigating through that particular space 86. In certain embodiments, one or more attributes corresponding to a particular radio tag 18, identifier of a particular radio tag 18, or the like may constitute navigation information for that tag 18 or identifier.

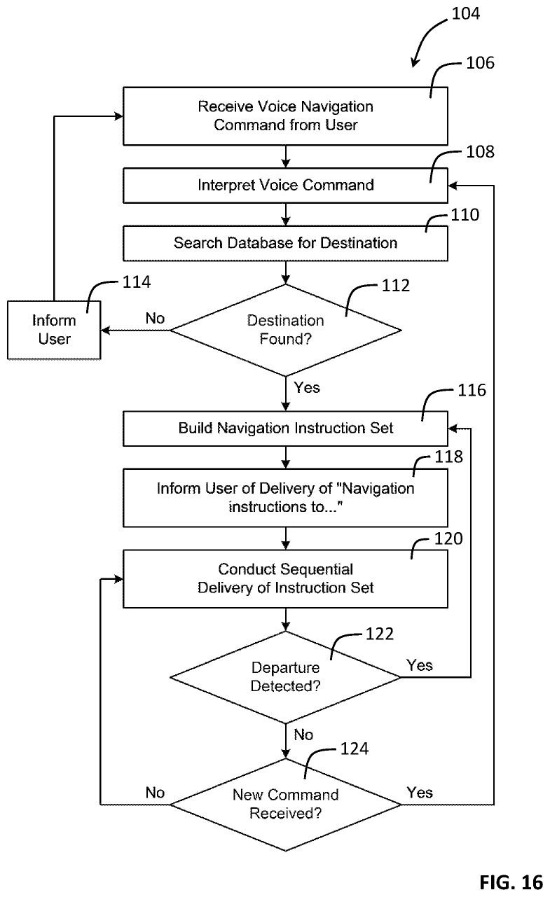

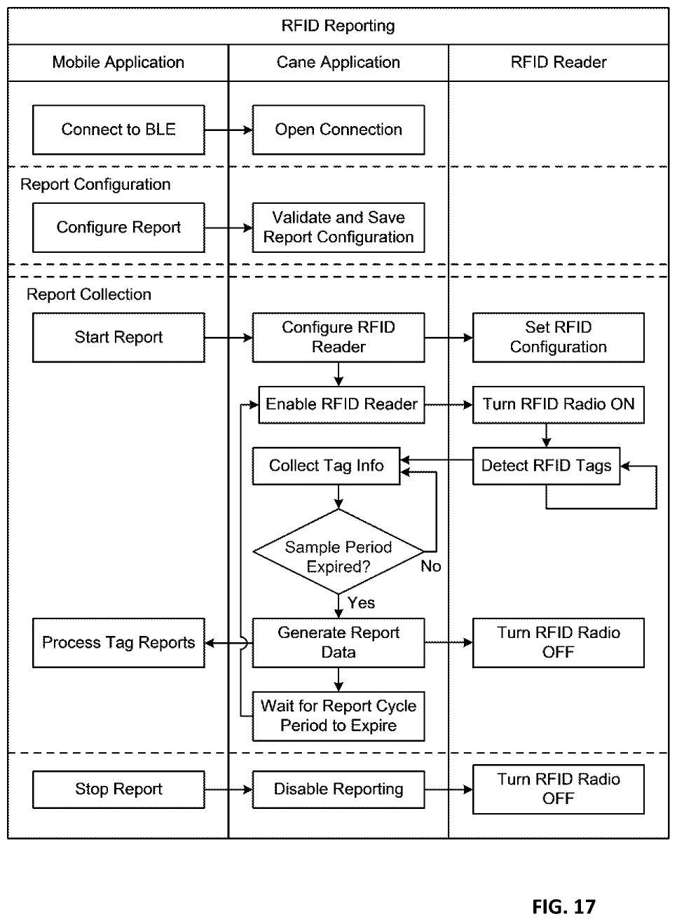

Referring to FIGS. 16 and 17, in selected embodiments, a method 104 for using a system 10 in accordance with the present invention may begin when a client device 16 (e.g., an application 68 running on a smart phone or other mobile device of a user 12) receives 106 a command from a user 12. Typically, this command may be received 106 as a voice command. Accordingly, a client device 16 may convert the command from speech to text (or leverage functionality of an operating system 40 to convert the command from speech to text) and then interpret 108 the command. If the command comprises a request to navigate to a destination, the client device 16 may search 110 a database, one or more tables, or the like to find the destination. As a result, a client device 16 may determine 112 whether the destination corresponding to the command is an identifiable destination within the system 10.

If the destination corresponding to the command is not found in the database, one or more tables, or the like, the client device 16 may inform 114 the user 12 that the destination is not found. This may give the user 12 the opportunity to learn (e.g., hear back) how the client device 16 interpreted his or her command. Accordingly, the user 12 may repeat or rephrase a command or issue a different command as he or she thinks best.

If the destination corresponding to the command is found in the database, one or more tables, or the like, the client device 16 may build 116 a navigation instruction set and then inform 118 the user 12 that what follows are “navigation instructions to . . . ” the particular destination. This may give the user 12 the opportunity to learn (e.g., hear back) how the client device 16 interpreted his or her command. Accordingly, the user 12 may repeat or rephrase a command or issue a different command as he or she thinks best. Alternatively, if the client device 16 properly interpreted the command, the user 12 may listen as the client device 16 conducts 120 a sequential delivery of the navigation instruction set.

A navigation instruction set may rely on one or more types of navigation aids. For example, a navigation instruction set may rely on GPS data and GPS-based instructions for navigating an outdoor portion of a route toward the destination. However, as the route toward the destination transitions from an outdoor environment to an indoor environment, the navigation instruction set may transition to relying on radio tags 18 and radio-tag-based instructions for continuing to navigate within the building toward the destination. Thus, a system in accordance with the present invention may support or generate navigation instruction sets that are entirely GPS based, entirely radio-tag based, or based on combined arrangement employing both GPS-based instructions and radio-tag-based instructions.

As a user 12 moves through an indoor space 86, a reading device 14 corresponding to the user 12 may encounter various radio tags 18 or transmissions issued by various radio tags 18. One example of such a process is illustrated in FIG. 17, which shows how a client device 16 (e.g., an application 68 running on a smart phone or other mobile device) may interact with software (i.e., a “Cane Application”) running on a computer processor (e.g., a microprocessor) associated with a cane 58 and the reading device 14 corresponding thereto and how that software (i.e., the “Cane Application”) may interface with a RFID reader that is also associated with the cane 58 and the reading device 14 corresponding thereto.

Various techniques may be used to determine which transmission (and hence which radio tag 18) corresponds to a current location of the user 12. For example, read count may be used to determine which radio tag 18 is closest to a reading device 14. Typically, the higher the read count, the closer the radio tag 18. Alternatively, or in addition thereto, received signal strength indicator (RSSI) may be used to determine which radio tag 18 is closest to a reading device 14. In certain embodiments, historical data (e.g., which radio tags 18 did the user 12 recently pass) may also be factored in when determining which radio tag 18 is now closest to a reading device 14.

By determining which radio tag 18 is currently closest to a reading device 14, a client device 16 may determine where a user 12 is in his or her progression to a destination. This may enable a client device 16 to determine when it is appropriate or necessary to issue a next instruction from the navigation instruction set. For example, when a user 12 draws near a particular radio tag 18, a client device 16 may determine that it is time to issue a command to “turn left and walk ten paces down the hall” or the like.

By determining which radio tag 18 is currently closest to a reading device 14, a client device 16 may also determine whether a user 12 has significantly departed from the path set forth in the navigation instruction set. Accordingly, when such a departure is detected 122, the client device 16 may build 116 a revised navigation instruction set and inform 118 the user 12 that it is “recalculating navigation instructions to . . . ” the particular destination. This may give the user 12 the opportunity to learn that he or she has moved off course, but that the client device 16 is making the necessary adjustments to correct the problem. A client device 16 may continue to conduct 120 a sequential delivery of navigation instructions until a user 12 reaches a destination, a new command is received 124 (e.g., a command corresponding to a new destination) from a user 12, or the like.

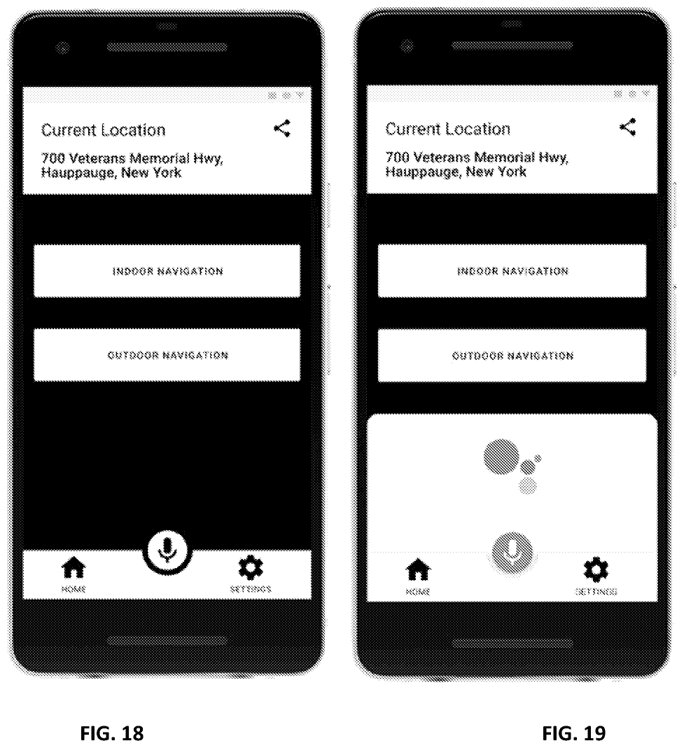

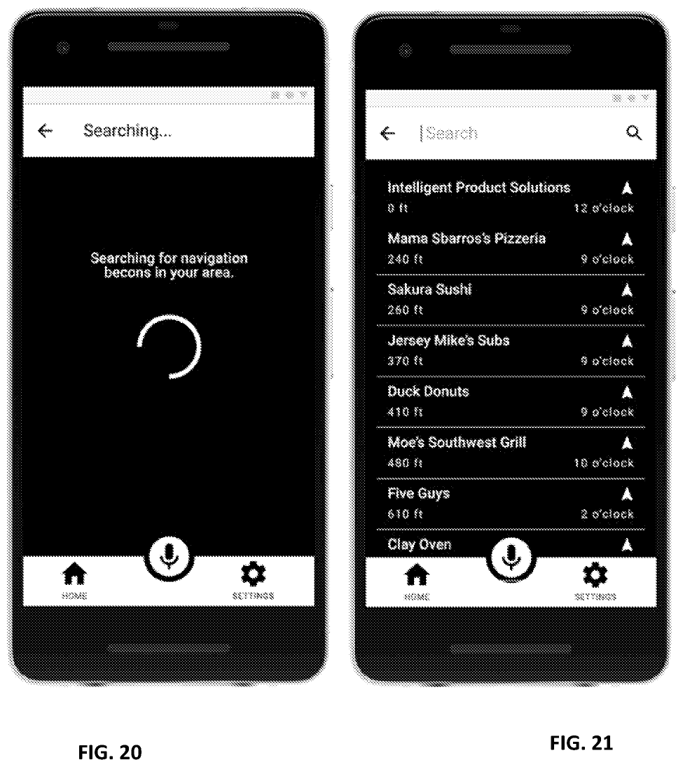

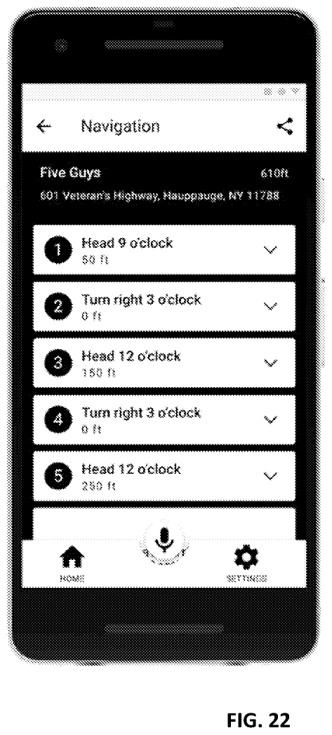

Referring to FIGS. 18-22, various screen shots are provided of one embodiment of a user interface of an application 68 running on a client device 16. For example, FIG. 18 provides a screen shot of a home screen of a user interface of the application 68. FIG. 19 provides a screen shot of the user interface as a voice command is being received by the application 68. FIG. 20 provides a screen shot of the user interface as the application 68 searches for information or data that may be responsive or relevant to a voice command received from a user 12. FIG. 21 is a screen shot of the user interface as the application 68 presents a listing of results (e.g., potential destinations) that may be responsive or relevant to a voice command received by the application 68. FIG. 22 is a screen shot of the user interface as the application 68 presents a navigation instruction set that will direct a user to a particular destination.

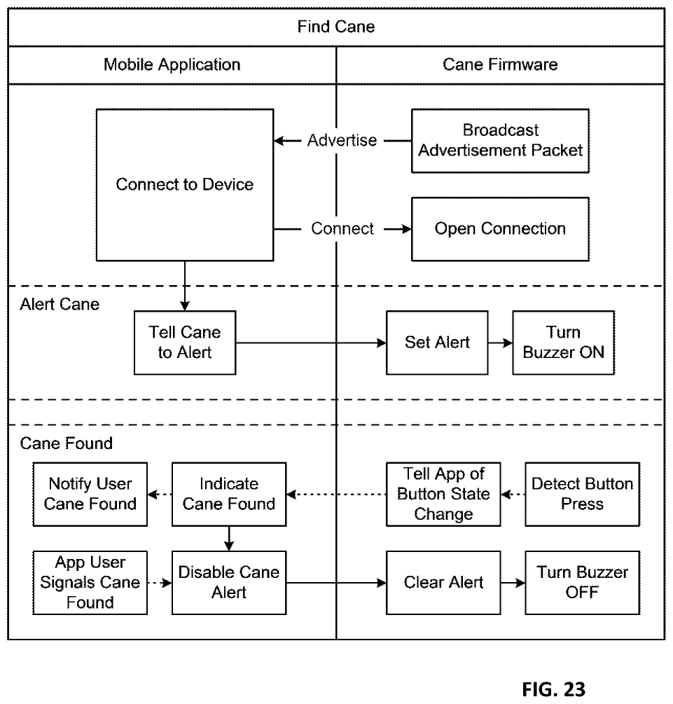

Referring to FIG. 23, in selected embodiments, a client device 16 (e.g., an application 64 running on a smart phone or other mobile device of a user 12) may support certain helpful functionality. For example, a client device 16 may support a cane-locating process that may assist a user 12 in locating a cane 58 that comprises or is connected to a reading device 14 in accordance with the present invention.

Example Embodiments, Features, and Uses

Selected embodiments of a system 10 in accordance with the present invention or certain components or features thereof may be referred to as “the cane system,” “the cane application,” “the cane,” etc. The cane system may comprise an UHF RFID reader equipped walking cane, assistive device, wearable, or the like that communicates over a BLE link or the like to a cane application on the user's smart phone. The cane application on the smart phone may also connect over the Internet to a webserver containing a tag ID database that contains a list of installed UHF RFID tags along with the associated location coordinates and any other details about the tag location that is deemed informative to the cane users, such as address, business name, office number, adjacent features, etc.

A. The Cane as a Navigation Tool

Reading UHF RFID tags embedded in the environment may enable a cane reader (or some other assistive device or wearable reader) to assist in determining a current location via a corresponding application query to a database in a Web server (e.g., a database storing tag maps or other information identifying the location of one or more tags). These tag locations may be overlayed in a global mapping application such as Google maps and assist and enhance the location functionality provided by the GPS capability of a smart phone. Based on the user's current location, the system may then provide navigation instructions to the user in order for him or her to get to his or her desired destination. This may be more valuable in high rise urban, indoor and subterranean environments where GPS is either inaccurate or unavailable.

Extra location precision and awareness via audible feedback may be enabled by using either received signal from the tag or tag read rate or a combination thereof to estimate distance of the cane (or some other assistive device or wearable) from the tag. Such techniques may also be used to inform the user whether he or she is approaching towards or receding away from the tag.

Additionally, buildings and environments outfitted with BLE beacons may communicate to the cane application to provide location and navigation assistance to the user. BLE beacons may be tags (e.g., tags powered by coin cell batteries) that identify locations that members of the public may use for location awareness and navigation within any facility.

B. The Cane as a Frictionless Access Control Tool or Badge

A cane (or some other assistive device or wearable) fitted with an RFID tag that uniquely identifies the user may provide a user with access control functionality to a room or building without requiring the user to present a contact or close proximity badge to a door reader. In this case, the door access would have a UHF RFID enabled reader and, on reading and authenticating the tag ID of the cane, the system may automatically unlock and open the door for the user. This may also open-up government and public facilities to the visually impaired for easier and more secure access. It may also be used for home entry and egress as well, with automatic door locking commanded via the cane.

C. The Cane to Enable Human Presence Detection

A cane (or some other assistive device or wearable) that is moving or in use may be sensed by one or more radio tags (e.g., one or more BLE beacons) in order to determine a location of a corresponding user. For safety and security applications in a building, it would be good to know if a person is in the building. Additionally, knowing a person's precise location within the building may be beneficial for emergency responders to locate and help evacuate the person (e.g., in the event of a fire). In non-safety applications, human presence detection may enable a building management system to adapt a rooms temperature, lighting, or sound system ambience to the presence of a person with an identifiable cane.

D. The Cane as a Finder Tool for Tagged Devices and Valuables

A user may use the cane (or some other assistive device or wearable) as a tool to locate items and valuables tagged with UHF tags by the user, items such as keys, wallet, remotes, books, luggage (e.g., luggage moving on a baggage claim carousel or conveyor system), or the like. With a distance estimation algorithm built into the cane software, the system may provide the user with real time audible or other feedback when they are getting either closer to the tagged item or going away from the item. Items may be uniquely identified by the RFID tag ID attached to the item and the user may issue a command to the application to, for example, “find my keys.” The application may then direct the cane to find only the RFID tag associated and attached to the keys and ignore other tags attached to other items.

E. The Cane as a Secure Key Mechanism for Cane Operation

A cane ID (or an ID corresponding to some other assistive device or wearable) and RFID tag ID may be paired to ensure only the valid owner of the cane may operate the RFID reader and other electronically controlled functions of the cane. In this example, the user may wear an RFID tag that is associated with the cane after the user buys the cane. Once paired, only that user may use the reader functions of the cane. This may also be accomplished via a BLE pairing of the cane to the MAC ID of the user's smart phone, but a wearable RFID tag may be more secure.

F. The Cane as a Shopping Assistant Tool

In more and more retail applications, items such as apparel are often tagged with UHF RFID tags. Accordingly, a user may use the cane (or some other assistive device or wearable) to read tagged items in a store. In this instance, the cane system may pass the tag ID up to the store ERP system and send a query to that system regarding details such as color, size, pricing, etc. and the store ERP system may send that information back to a cane application corresponding to the user, which may then send the user audible details.

G. The Cane as a Panic/Emergency Alert Tool

A user with the cane (or some other assistive device or wearable) may use a feature of the cane to alert nearby people of an assault or other critical condition or situation and/or automatically command the user's phone to dial 911 or some other emergency number for assistance. The cane system may automatically forward precise user location data to the authorities equipped with enhanced 911 system capabilities that would be augmented or enhanced with the current or last know tag read location identified by the cane as well as any GPS coordinates available from the smart phone.

H. The Cane as a People Finding Tool

Visually impaired people using the canes (or some other assistive devices or wearables) may use the system to either sense nearby users or locate and meet up with each other at a set designation located with an RFID tag. How this is done may be with a tag inside each cane that identifies the user for proximity detection or the cane application to alert users to the location of other cane users in that user's friend or associate list. Another method may be that the cane smart phone application sends the cane ID that may be unique and associated with the user along with the read tag ID and timestamp to the cane system webserver and database which can then allow groups to access the where-abouts of each other.

I. Off-Line Operational mode

For deep indoor and/or subterranean environments where both cellular and GNSS connectivity is not possible the cane system may batch the users desired path information beforehand into the smart phone application, which may then act as a local tag ID database and alert the user to their whereabouts from reading those tags along the path.

J. Tag Distance Estimation

The cane application may enable calculating tag distance based on tag RSSI and tag read rate. This may enable a user to pinpoint the tag position to within a couple of feet, which may be useful for certain applications such as identifying doorways and the whereabouts of small items, such as keys, phones, wallets, and other small valuables.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A method comprising:
sending, to a remote server, information identifying a first location within a building;
receiving, from the remote server in response to the sending, data comprising a plurality of unique identifiers, each unique identifier of the plurality of unique identifiers corresponding to a unique radio tag located in a unique location within the building; and
using the data to deliver to a user a first series of audible commands guiding the user within the building toward the first location.

2. The method of claim 1, further comprising receiving a first radio transmission from a first radio tag located within the building.

3. The method of claim 2, wherein:
the first radio transmission communicates a first identifier; and
the first radio tag is a passive RFID tag, an active RFID tag, or a radio beacon.

4. The method of claim 3, wherein:
the first identifier is associated within the data to first navigation information; and
the using comprises using the first navigation information to guide the user within the building toward the first location.

5. The method of claim 4, further comprising receiving a second radio transmission from a second radio tag located within the building, the second radio transmission communicating a second identifier.

6. The method of claim 5, wherein:
the second identifier is associated within the data to second navigation information; and
the using comprises using the second navigation information to guide the user within the building toward the first location.

7. The method of claim 1, further comprising receiving, from the user, information identifying a second location within the building.

8. The method of claim 7, further comprising using the data to issue a second series of audible commands that guide the user within the building toward the second location.

9. The method of claim 8, further comprising arriving at the first location.

10. The method of claim 9, wherein the receiving the information identifying the second location occurs after the arriving at the first location.

11. A system comprising:
at least one processor;
memory operably connected to the at least one processor; and
the memory storing data comprising
a plurality of unique identifiers, each unique identifier of the plurality of unique identifiers corresponding to a unique radio tag located in a unique location within a building, and
one or more attributes for the each unique identifier, the one or more attributes characterizing the unique location within the building at which the unique radio tag corresponding to the each unique identifier is located.

12. The system of claim 11, wherein:
the plurality of unique identifiers comprises a first unique identifier, a second unique identifier, and a third unique identifier;
the first unique identifier corresponds to a first unique radio tag located in a first unique location within the building;
the second unique identifier corresponds to a second unique radio tag located in a second unique location within the building; and
the third unique identifier corresponds to a third unique radio tag located in a third unique location within the building.

13. The system of claim 11, wherein:
the one or more attributes for the first unique identifier characterize the first unique location;
the one or more attributes for the second unique identifier characterize the second unique location; and
the one or more attributes for the third unique identifier characterize the third unique location.

14. The system of claim 13, wherein the one or more attributes for the first unique identifier characterize the first unique location as being adjacent an entrance to a restroom contained within the building.

15. The system of claim 13, wherein the one or more attributes for the first unique identifier characterize the first unique location as being adjacent an entrance to an elevator contained within the building.

16. The system of claim 13, wherein the one or more attributes for the first unique identifier characterize the first unique location as being adjacent an entrance to an office contained within the building.

17. A method comprising:
virtually dividing at least a portion of a floor of a building into a plurality of sections;
mapping the plurality of sections to a plurality of radio tags such that one radio tag of the plurality of radio tags corresponds to one section of the plurality of sections;
programming the plurality of radio tags such that each radio tag thereof has a unique identifier;
installing the plurality of radio tags within the building according to the mapping; and
programming in a computer system a mapping of the unique identifier of the each radio tag of the plurality of radio tags to one or more attributes of a section of the plurality of sections corresponding to the each radio tag.

18. The method of claim 17, wherein:
the plurality of radio tags comprises a first radio tag, a second radio tag, and a third radio tag; and
the installing comprises installing the first radio tag within a first section of the plurality of sections, the second radio tag within a second section of the plurality of sections, and the third radio tag within a third section of the plurality of sections.

19. The method of claim 18, wherein the programming comprises programming the first radio tag with a first unique identifier, the second radio tag with a second unique identifier, and the third radio tag with a third unique identifier.

20. The method of claim 19, wherein the one or more attributes for the first unique identifier characterize the first section as being adjacent to an entrance to a restroom contained within the building, an entrance to an elevator contained within the building, or an entrance to an office contained within the building.
